(19) United States
(12) Patent Application Publication
(10) Pub. No.: US 2004/0080412 A1
(43) Pub. Date: Apr. 29, 2004

(54) Location requests by a network device

(76) Inventors: Mark T. Smith, San Mateo, CA (US); Gerald Maguire, Stokcholm (SE)

Correspondence Address: HEWLETT-PACKARD COMPANY, Intellectual Property Administration, P.O. Box 272400, Fort Collins, CO, 80527-2400, US

(21) Appl. No.: 10/280,454

(22) Filed: Oct. 26, 2002

(51) Int. Cl. G08B 1/08

(52) U.S. Cl. 340/539.13

(57) ABSTRACT

A system includes a network device, and a locator for determining location of the network device. The network device includes a network interface for communication with the locator, and a motion sensor and controller for detecting motion of the network device. The controller sends a location request to the locator when motion of the network device has been detected.

### BACKGROUND

Certain mobile devices need to know their locations. Knowledge of location allows these mobile devices to execute “location-aware” applications. Examples of location-aware applications include applications for tracking assets and people, applications for finding buildings (e.g., hotels, restaurants), applications for emergency response (e.g., finding accident victims), applications for identifying vehicles (e.g., trains, buses), and applications for wireless device handoff. Examples of location-aware mobile network devices 114 include, without limitation, cell phones, laptop computers, and PDAs.

A location-aware network device that is connected to a network can obtain its location by sending a location request to a “locator.” The locator can use IR beacons, signal strength, a global positioning system or other technique for determining the location of the network device. The location requests are typically made at fixed intervals of time.

### SUMMARY

According to one aspect of the present invention, a system includes a network device, and a locator for determining location of the network device. The network device includes a network interface for communication with the locator, and a motion sensor and controller for detecting motion of the network device. The controller sends a location request to the network interface when motion of the network device has been detected.

Other aspects and advantages of the present invention will bercome apparent from the following detailed description, taken in conjunction with the accompanying drawings, illustrating by way of example the principles of the present invention.

### BRIEF DESCRIPTION OF THE DRAWINGS

FIG. 1 is an illustration of a system according to an embodiment of the present invention.

FIG. 2 is an illustration of the operation of a network device according to an embodiment of the present invention.

### DETAILED DESCRIPTION

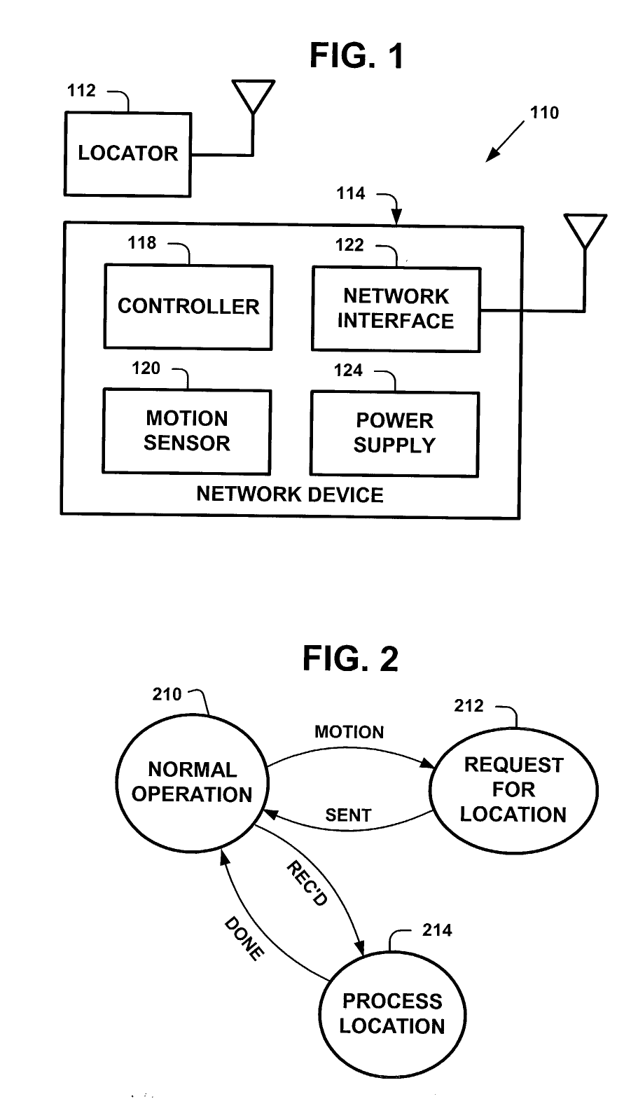

Reference is made to FIG. 1 , which illustrates a system 110 including a locator 112 and a network device 114. The locator 112 and the network device 114 communicate via a wireless network.

The locator 112 can determine the location of the network device 114. There is no limitation as to how the location can be determined. For example, the locator 112 can determine the location of the network device 114 by way of IR beacons, signal strength, a global positioning system, radar, triangulation based on message arrival, visual sensors (e.g., cameras), environmental sensors that can track the user (e.g., switches in the floor or in doors, light beams), proximity sensors, etc.

The network device 114 is preferably a mobile device that is location-aware. Examples of such mobile network devices 114 include, without limitation, cell phones, laptop computers, PDAs, cars, wristwatches, shoes, and special purpose devices such as ID tags.

The locator 112 can determine the location of the network device 114 and communicate that location to the network device 114 when the network device 114 connects to the network. The locator 112 can also determine the location of the network device 114 and communicate that location to the network device 114 when the network device 114 requests the location from the locator 112. The location request is sent over the network.

The network device 114 includes a controller 118 (e.g., a processor and memory), a motion sensor 120, a wireless network interface 122, and an on-board power supply 124 (e.g., batteries). The controller 118 and the motion sensor 120 cooperate to determine when the network device has been moved. Examples of motion sensors 120 include, without limitation, piezoelectric accelerometers, magnetic compasses, gyroscopes, optical sensors, tilt sensors, pressure sensors, and sensors that detect changes in received signal strength (e.g., device movement is detected from a change in signal strength of something it is listening to).

The controller 118 and the motion sensor 120 may be dedicated to detecting the motion of the network device 114, or they may also perform other functions of the network device 114. Other functions include measuring speed, orientation, altitude change, relative position, etc. Orientation could be with respect to the user, with respect to the device 114 itself, etc.

Additional reference is made to FIG. 2, which illustrates the operation of the network device 114 after it has already been connected to the network. The device performs its normal operation, if any (state 210). When the controller 118 and the motion sensor 120 determine that the network device 114 has been moved, the controller 118 generates a location request, and sends the location request to the network interface 122 (state 212). The network interface 122, in turn, sends the location request to the locator 112 via the wireless network. After the location request has been sent, the network device 114 resumes its normal operation (state 210).

In response to the request, the locator 112 determines the location of the network device 114, and sends the location to the network device 114. The network device 114 receives the location via the network, and updates its location, stores, or otherwise processes the location information (state 214). The processing may include using the location in a location-aware application. After processing has been completed, the network device 114 resumes its normal operation (state 210).

There is no limitation as to how motion is detected and when the location request is sent. For example, the request could be sent as soon as motion is detected, as soon as motion has stopped, repeatedly during motion at different intervals based on the magnitude or direction of the motion, etc. The network device 114 might send a request only if substantial motion is detected. Substantial motion could be detected by comparing magnitude of the detected motion to a threshold.

There are advantages to requesting the location only when motion is detected (as compared to a network device that sends requests at fixed intervals). Less power is consumed by the network device 114, since fewer location requests are generated and transmitted. Consequently, life of the power supply 124 is increased. Computational resources of the network device 114 are also preserved. Network traffic is reduced, since the number of location requests by the network device 114 and responses by the locator 112 are reduced. This last advantage becomes significant when large numbers of network devices 114 are connected to the network.

FIG. 1 illustrates only a single network device 114 connected to the network. However, the system 110 may include additional network devices 114.

The locator 112 is not limited to any particular type of machine. For example, the locator 112 could be a server, an access point, a special purpose device such as a dedicated listener or tracker, or another peer device. The locator 112 may be one of many, acting alone or in a coordinated manner.

The network device 114 is not limited to the types indicated above. For example, the network device 114 could be an asset (e.g., equipment, a package, a rental car). The system 110 would provide tracking of the asset. Other applications might include, without limitation, automatic service or resource discovery based on location, navigation applications (e.g., directions to a hotel), and information applications (e.g., identifying a building).

The network is not limited to a wireless network. For example, the network device 114 could be wired to the locator 112.

The system is not limited to a remote locator (e.g., a locator that is connected to a network). Instead, a location device could be on-board the network device. For example, a GPS radio could be contained within a PDA. Location requests would be sent to the on-board location device only when motion is detected. Thus power consumption would be reduced. Processing would also be reduced, as previous data would be used. Moreover, network traffic arising from location requests would be further reduced.

The present invention is not limited to the specific embodiment described above. Instead, the present invention is construed according to the claims that follow.

1. A system comprising:
a network device; and
a locator for determining location of the network device;
the network device including a network interface for communication with the locator, and a motion sensor and controller for detecting motion of the network device, the controller sending a location request to the locator when motion of the network device has been detected.

2. The system of claim 1, wherein the network device is a cell phone.

3. The system of claim 1, wherein the network interface is a wireless network interface.

4. The system of claim 1, wherein the locator sends an updated location to the device in response to the request.

5. The system of claim 4, wherein the device receives the updated location from the locator and processes the updated location.

6. The system of claim 5, wherein the device uses a location-aware application to process the location.

7. A network device comprising:
a motion sensor; and
a controller;
the motion sensor and the controller cooperating to detect motion of the network device, the controller generating a location request when motion of the network device has been detected.

8. The device of claim 7, wherein the network device is a cell phone.

9. The device of claim 7, further comprising a network interface, the controller sending the location request to the network interface when motion of the network device has been detected.

10. The device of claim 9, wherein the network interface is a wireless network interface.

11. The device of claim 9, wherein the controller receives the updated location from the network interface and processes the updated location.

12. The device of claim 7, wherein the controller uses a location-aware application to process the location.

13. The device of claim 7, further comprising an on-board location device, the controller requesting location information from the location device when motion of the network device has been detected.

14. A method of updating location of a network device, the method comprising:
detecting when motion of the device as occurred; and
sending a request for location of the device only when motion has been detected.

15. The method of claim 14, wherein a wireless network interface is used to send the location request and receive a location in response to the request.

16. The method of claim 15, further comprising processing the location received in response to the request.

17. The method system of claim 16, wherein the location is processed with a location-aware application.
